(19) United States
(12) Patent Application Publication
(10) Pub. No.: US 2019/0303978 A1
(43) Pub. Date: Oct. 3, 2019

(54) Mute Advertising Method

(71) Applicant: THEOCHARIS ZACHARATOS, Nicosia (CY)

(72) Inventor: THEOCHARIS ZACHARATOS, Nicosia (CY)

(73) Assignee: CELLOCK LTD, NICOSIA (CY)

(21) Appl. No.: 16/442,494

(22) Filed: Jun. 15, 2019

(51) Int. Cl. G06Q 30/02; G06Q 50/00

(52) U.S. Cl. CPC G06Q 30/0272; G06Q 50/01

(57) ABSTRACT

A method for determining when advertisements should stop being served to a specific group of consumers, namely travellers, which uses a combination of data from online and offline behaviour and related that data to characteristics of a trip. The advertisements are provided while travellers are onboard public transport means and a key element is the relevance of information that is provided at every stage of the trip to determine the advertisement relevance for Continuation.

### BACKGROUND OF THE INVENTION

With the use of mobile smart devices (phones or tablets) reaching nearly 100% in some countries, the advertising industry has a strong interest in targeting potential buyers through mobile devices. When users show interest to some goods or services by visiting a website, an ad may be triggered. The term “Interest-based advertising” is often used to mean the display of ads according to a user's past online activity and interests. Online advertisers, with the help of browser cookies, can track users across the web and serve relevant advertising. Depending on a user's online activity cookies are added to a pool of cookies to enable re-targeting that user. This can be very effective in terms of conversions from prospect to buyer. When users purchase the product, they are removed from the pool of targeted users for ads. If they do not purchase, then they will continue to be served those ads. But after a while, those ads, that continue to be displayed, become ineffective. The advertising industry can have huge monetary losses in money paid to display ads that should not be displayed. The key question is when to stop displaying an ad or a bundle or related ads.

In general, the decision to stop displaying an ad can be done in a deterministic or in a probabilistic manner.

In a deterministic manner, when it is confirmed that a user has purchased the product, the ads stop. This is not always possible however, because the user may purchase the product from an alternative retailer online or offline, the user may purchase a substitute product, or somebody else may buy the product for the user.

Probabilistic methods of assessing whether there is continued interest by the user to purchase the product or whether the user had already purchased the product, combine several proxies to calculate the probability that the user should be out of the pool of prospects. These proxies may include location-based indicators such as the time spent near a certain store, the time interval between repeated visits to a website, and so on. Probabilistic methods face many challenges, the most important one being availability of sufficient data from more than one website and the access to data that may be related to an offline purchase.

Another way to stop the displaying of no-longer relevant ads, is that users take purposeful action; this is not originating from advertisers or publishers but consumers themselves.

Methods of determining that the display of ads should be stopped, face challenges but these challenges are different for different consumer groups. For some consumer groups the assessment of whether an ad should stop to be served can be made more reliably. One such consumer group is travelers.

It is the objective of this invention to provide a method for determining whether and when the serving of on ad or a group of ads to travelers should be terminated.

### SUMMARY OF THE INVENTION

The invention focuses on determining when ads should stop being served to a specific group of consumers, namely travellers. By the term travellers, we refer to anybody that is travelling by public transportation means, airplanes, trains, ships. In these public transportation means, travellers are in most cases able to connect to internet via a system provided by onboard systems. For example, an air traveller would register through the aircraft's internet provision system and would have to consent to the system's data policy in a similar way that somebody that utilises the Google search engine would have accepted that Google can collect and process data, within certain privacy provisions. Access to data is thus possible.

Travellers have anticipated behaviours at different stages of a trip. For example, whilst on the airplane somebody is in the mood of spending time, and one way of doing that is exploring purchase options for articles or services he is interested in. Some of those may be purchased whilst on the airplane. The purchase may be from the stock on the airplane or via the internet from another online retailer. The purchase may also happen later, not while being on that airplane. The purchase may be for example done offline, from a physical retailer. This retailer may be at the destination or elsewhere. For travellers the correlations of searches to intentions are stronger than for other types of consumers. For example, when a traveller searches through maps for the address and location of physical stores at the destination selling a specific item, there is a very high probability that he intends to visit and possibly buy.

Values for a set of variables that characterise the trip and the behaviour of the traveller can be used to assess whether a specific ad should continue to be served to that traveller or not. The set of variables that characterise the trip may include purpose of the trip, duration of the trip, destination, time of arrival, estimated delays, retailers at destination port (airport, train station, ship terminal), retailers at destination selling the advertised product. A weighted average of these variables is used to calculate an Ad Relevance for Continuation (ARC) which is updated periodically. Based on the ARC value and its comparison to a threshold, an assessment is made if an ad should stop being served altogether or if an ad should not be served at the next stage of the strip.

### BRIEF DESCRIPTION OF THE DRAWINGS

The details of one or more implementations of the invention are set forth in the accompanying drawings and the description below. These drawings are provided for clarification of the claims and represent examples of embodiments.

FIG. 1 shows the modes by which information can be provided to a traveller whilst on board transportation means.

FIG. 2 illustrates the verification process once the user reaches a destination port or is otherwise able to directly connect to internet.

FIG. 3 illustrates schematically how a data processing system processes information to determine whether to send a mute instruction to the Ads serving system.

FIG. 4 illustrates schematically how a weighted average ARC (Ad Relevance Continuation) value is calculated and compared to threshold for the data processing system to decide for a mute instruction.

FIGS. 5a, 5b and 5c illustrate the stages of a trip

FIG. 6 illustrates multiple groups within which a user may belong

FIG. 7 illustrates how a social graph is used to inform the “Weight review System”

FIG. 8 illustrates by means of example of one embodiment, how virtual and physical behaviour is captured and recorded to create cookies at each stage of the trip

FIG. 9 illustrates how the user's location is captured, interpreted, and used to inform the Data Management System

FIG. 10 illustrates how the threshold adjustment system is informed to adjust the threshold level.

### DETAILED DESCRIPTION OF THE PREFERRED EMBODIMENTS

A method for determining when ads should stop being served to a specific group of consumers, namely travellers is presented, which uses a combination of data from online and offline behavior and relates that data to characteristics of a trip.

One aspect of the invention comprises a method for verifying that an ad served offline through the communication platform of a travel means such as an aircraft has indeed been received. Once the user connects to the internet an app on the user's mobile device connects to the internet and a verification procedure is run.

One other aspect of the invention comprises a communication platform on travel means which provides offline content and, in some cases, acts as a bridge to internet connection. This communication platform enables users to purchase merchandise (e.g. physical merchandise that they can buy onboard), to consume content (e.g. movies and news), and serves them appropriate ads. Ads are purchased in bulk by thirty party advertisers in advance and are served to different users during the trip.

Ads are typically repeated over a period of time. The instruction to stop is referred to here as Mute Instruction. A Mute instruction is useful in order to avoid unnecessary expenditure by advertisers and to avoid frustrating users. The behavior, i.e. the actions after obtaining advertisement information, can be monitored to determine when a Mute Instruction should be given.

Preferred embodiments of the invention are described with reference to the figures. It is noted that the following description contains examples only and should not be construed as limiting the invention.

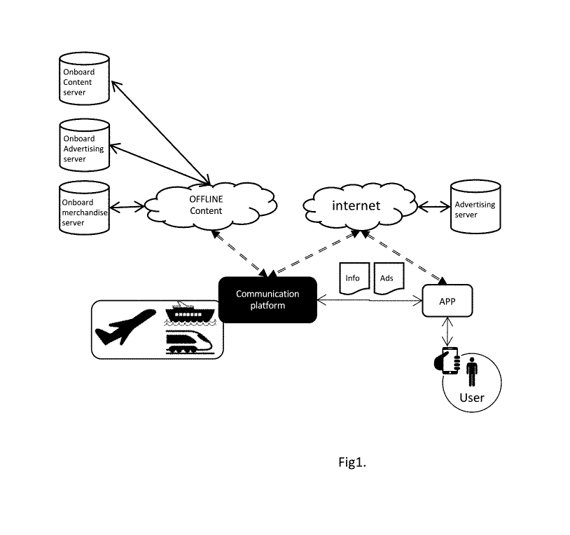

FIG. 1 illustrates how a communication platform of a travel means is utilized. Such communication platform is useful because it can provide a means for controlling and monitoring content exchanged by the app on a user's mobile device. The communication device becomes the communication bridge of the user. This may be either as a platform to provide offline content or as a means to provide free Wi-Fi connection to internet. The fact that for many transports means such as aircraft, ships, or trains signal reception by a mobile device is impossible or extremely poor, means that users seek the connection to such communication platform. Offline content may be access to the transport (e.g. aircraft's) merchandise shop, physical or virtual. A physical shop may refer to the merchandise that an aircraft, ship, or train may physically hold. This may be food or other items such as perfumes, gifts etc. that are frequently sold aboard. A virtual shop may be a shop that the transport company operates. An example of that is the Lufthansa WorldShop. (https://www.worldshop.eu). Access to such shops may be both online and offline, and whilst onboard the transport means the communication is via the communication platform.

To fully utilize features provided by the communication platform, a user would need to install an app on his mobile device. It is possible that the same app that is used for booking travel, such as an airline's app, also performs the role for access to features of the communication platform. The access to advanced functionality encourages users to download and install the app on the mobile device.

When a user is on an aircraft, train, or ship, and uses the communication platform, he may be served with ads. These ads are stored on the Onboard Advertising Server. When a user disconnects from the Communication Platform, for example upon arrival at destination, the app on his mobile device will connect with internet at the first occasion that signal is available or when the user otherwise connects to Wi-fi. The app at that instance will communicate with an Advertising server. The app will verify with the Advertising Server that the mobile device has been served with certain ads.

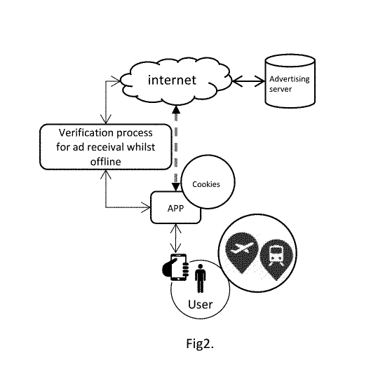

FIG. 2 illustrates how a communication of the app takes place with the Advertising Server to verify that (when the user was offline) specific ads were received. The cookies created and stored on the app while the app was offline, and in communication with the Communication Platform of the aircraft, train or ship, are passed to the Advertising Server. This confirms that indeed the user had been provided with a specific ad.

The ads provided to a user may include information related to goods or services offered by a business which sells goods or services related to the trip. Ads may continue to be served to the user for a number of times and over a period of time until a Mute Instruction is issued instructing any linked advertising servers to stop serving ads.

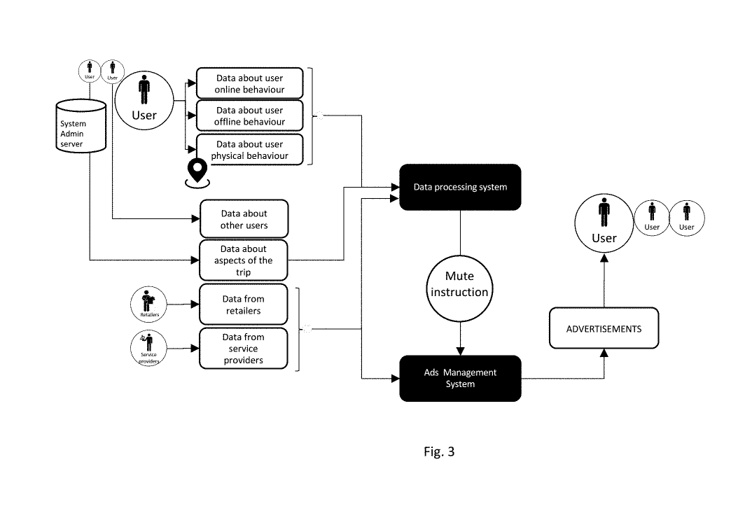

FIG. 3 illustrates how a Data Processing System (DPS) and an Ads Management System (AMS), within the app on the user's mobile device, operate to determine whether a Mute Instruction should be issued. The DPS receives data about user online behavior, user offline behavior, and user physical behavior. User online behavior refers to online searches, visits to websites and clicks that the user carries out whilst online. User offline behavior refers to information that the user consumes, products that he browses through and so on whilst connected with the Communication Platform of the transport system (aircraft, train, ship). User physical behavior refers to physical actions of the user that can be recorded and registered. For example, visit to a brick-and-mortar shop that can be determined based on location data. Another example of physical behavior that can be recorded is purchase data linked to location, when for example the mobile device is used as a virtual wallet.

The DPS also receives data about other users from the System Admin Server. The System Admin Server, is a central server with which the apps communicate, and which can store and relate information from multiple users.

The DPS also receives data from the System Admin Server about aspects of the trip. Aspects of the trip include estimated and actual departure time, actual and estimated arrival time, arrival destination, weather, availability of physical shops by type at destination and so on.

The DPS also receives data from connected retailers and service providers. This enables the DPS to determine a confirmed purchase or the probability of a purchase following the provision of a related advertisement.

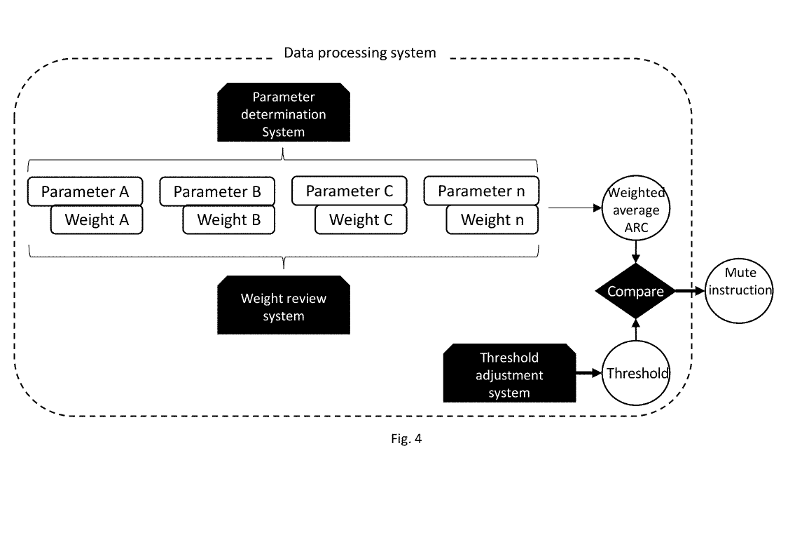

FIG. 4 illustrates how the Data Processing System (DPS) processes information. The DPS comprises of three main subsystems, namely, the Parameter Determination System (PDS), the Weight Review System (WRS), and the Threshold Adjustment System (TAS).

The Parameter Determination System (PDS) determines which parameters are relevant for calculation of Ad Relevance Continuation (ARC). These parameters refer to likelihood of purchase and to the continued relevance of a product or service for the user. These parameters fall into several categories. These categories of parameters comprise, location of service provider in comparison with location of user, alternative supplier, alternative product, time-window dependence, stages of the trip, and response of other people following receipt of similar ads.

The Weight Review System (WRS), dynamically assigns weights to each parameter. For example, for parameters in the category of location, the weight of those parameters is dynamically reduced as the gap between location of user and location of service provider widens until a threshold when the WRS may then assign a zero weight to eliminate the relevance of that parameter.

Parameters are multiplied by their assigned weight to produce a Weighted Average ARC (weighted average Ad Relevance Continuation). The weighted average ARC is compared to a Threshold. When the Weighted average ARC is lower than the Threshold, a Mute Instruction is issued. The Mute Instruction is like a termination instruction which when received by the Ads Management System, it will stop all ads about a product or service from being sent to that user, for a determined period of time. This period is referred to as the Ad Quiet Time (AQT). The AQT will be indefinite until a stimulus is received due to a user action. The stimulus may be, for example, a user's online behavior searching for a similar product. If no relevant stimulus is received the ad will never be served again to the user. If a stimulus is received, an ad may be served but after reassessment following the lapse of the AQT.

The Threshold Adjustment System sets the Threshold based on factors related on the one side to user preferences and characteristics and on the other side to advertiser preferences and advertising budget. This adjustment may be done dynamically.

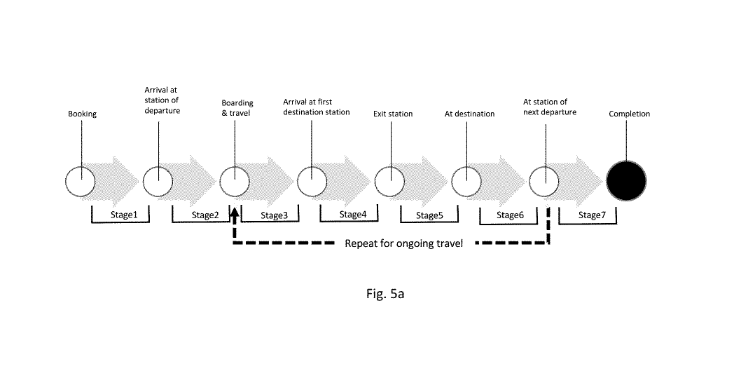

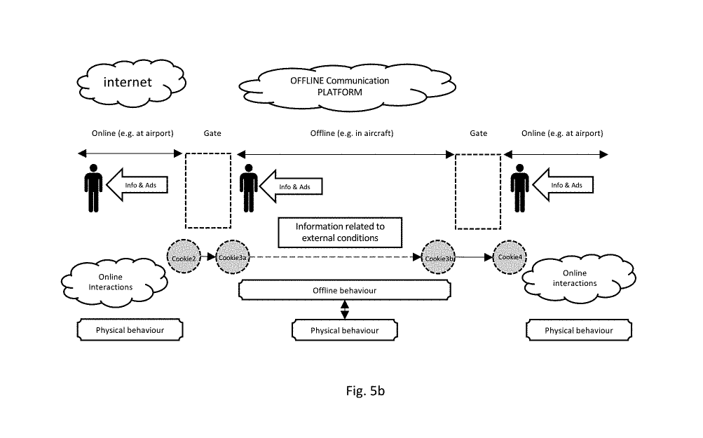

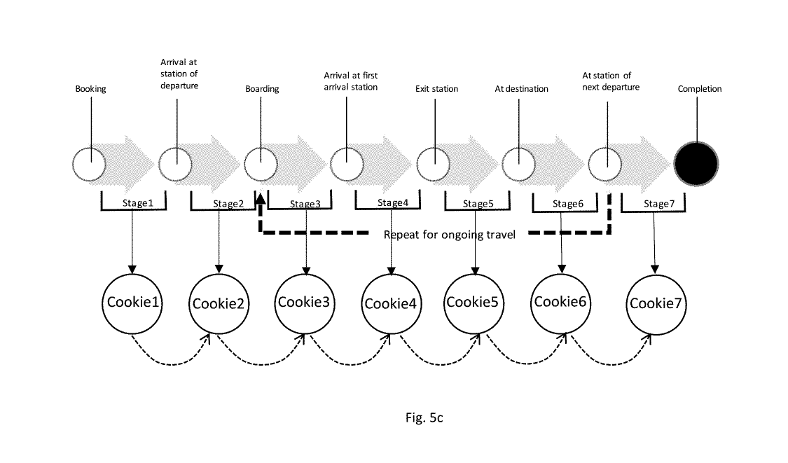

FIG. 5a illustrates stages of a trip. These stages comprise booking, arrival at station of departure, boarding and travel, arrival at first destination station, exit from destination station, time at destination, arrival at station of next departure when the trip includes outward and return travel or outward and connecting travel.

The stages of the trip comprise one very important category of parameters that are being used by the PDS for calculation of the Weighted Average ARC. The stages of the trip are also being used by the Ads Management System to select relevant Ads that may be served to the user.

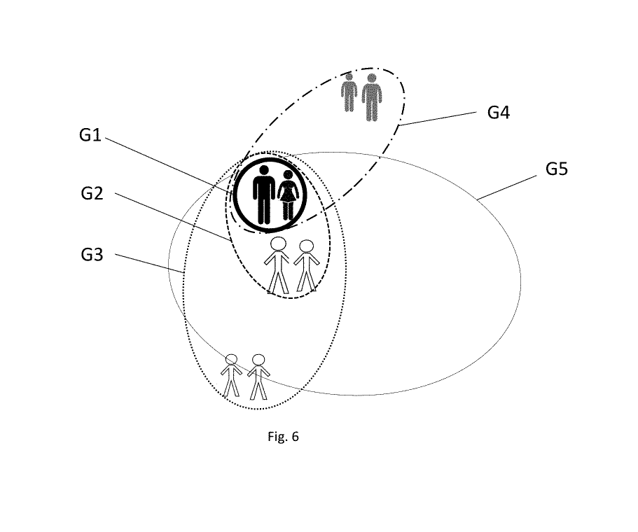

FIG. 6 illustrates different groups that a user may belong to. In one preferred embodiment of the invention, five groups are defined:

Group 1 (G1): User's family and spouse,

Group 2 (G2): User's Co-travellers like family, friends and business colleagues under the same booking

Group 3 (G3): People travelling on the same trip same mode (e.g. on the same flight), but not on the same booking

Group 4 (G4): People that have taken the same trip before or that have travelled from the same departure to the same destination before,

Group 5 (G5): The broader social groups of the user like social network groups.

The personal Travel Graph is particularly linked to other users belonging to Group 2 and Group 3 that are travelling on the same transportation means (e.g. on the same flight). When the user is online again the PTOG is used to update the users Personal Travel Graph that is related to up to date associations that refer to what is happening to other groups. In the preferred embodiment the primary mechanism by which behaviour is captured is via cookies. Cookies are generated at each stage of the trip.

As a user passes from one stage of a trip to another, cookies are passed so that the data tags contained in one cookie are used to update another cookie for the next stage of the trip. As illustrated by FIG. 5b and FIG. 5c in one preferred embodiment cookies are passed from one stage of the trip to another. Cookies can be both online cookies and offline cookies. For example, a cookie at stage 2 of the trip, referred to as cookie 2, is used to merge the tags with another cookie, cookie 3, that collects data from stage 3 of the rip.

FIG. 5b illustrates by means of example of one embodiment, how virtual and physical behaviour is captured and recorded to create cookies at each stage of the trip, and then convert the tags from these cookies to update a user's Graph. User's social graphs are updated according to both physical and virtual behaviour. Virtual behaviour is captured both when the user in online and when the user is offline. Physical and virtual behaviour is captured by cookies, and the data captured by cookies is converted to tags which are then assigned to the user's unique ID that enables the Travel Graph and hence the Social Graph to be updated. Regardless of whether the user is online or offline data about the user's physical and virtual behaviour is always captured by cookies. During the different stages of the trip data contained in online and in offline cookies is merged.

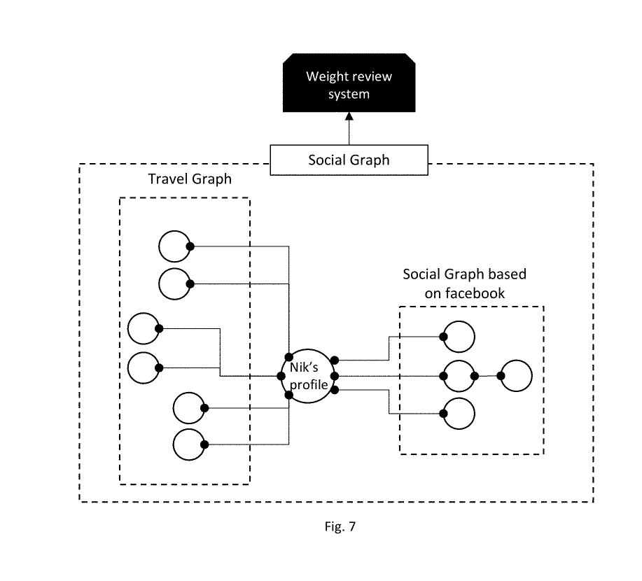

FIG. 7 schematically illustrates how a user's Social Graph is utilized by the Weight Review System (WRS). The Social Graph comprises a combination of the Travel Graph and the user's social graph based in Facebook. The user's Graph is updated based on virtual behaviour online and offline, and physical behaviour. Tags related to real and virtual actions of the user are assigned to the user and incorporated to his Travel Graph. A Graph links user of all groups according to their relationship. This graph remains operational both online and offline. A user has his Personal Travel Graph that characterises the user in relation to the other users of different groups. When the user is online his Personal Travel Graph is updated in relation to associations that refer to what is happening to other groups. When the user goes offline, his Personal Travel Graph is updated only with regards to his own actions that can be registered offline (Personal Travel Offline Graph—PTOG) on his mobile device. This Personal Offline Travel Graph is linked to a Group offline graph which contains the preferences and actions of members of relevant groups.

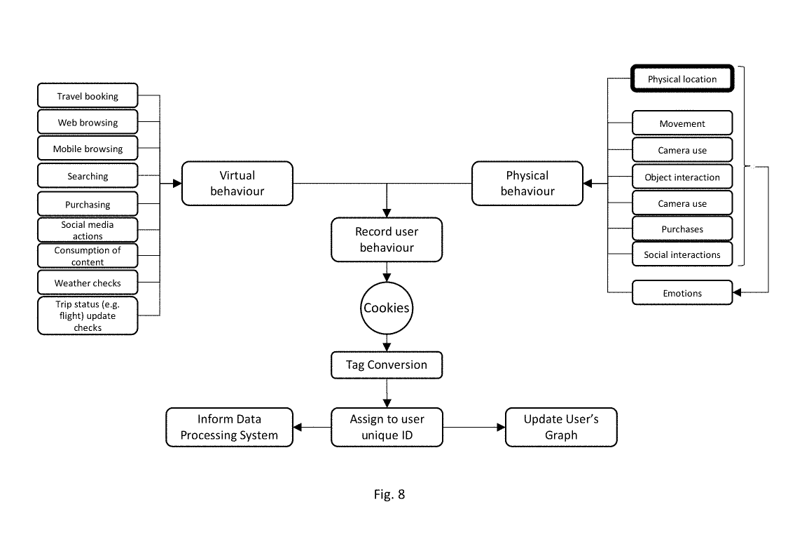

FIG. 8 illustrates by means of example of one embodiment, how virtual and physical behaviour is captured and recorded to create cookies at each stage of the trip, and then convert the tags from these cookies to update a user's Graph and inform the Data Processing System. User's social graphs are updated according to both physical and virtual behaviour. Virtual behaviour is captured both when the user in online and when the user is offline. Physical and virtual behaviour is captured by cookies, and the data captured by cookies is converted to tags which are then assigned to the user's unique ID that enables the Travel Graph and hence the Social Graph to be updated. Regardless of whether the user is online or offline data about the user's physical and virtual behaviour is always captured by cookies. During the different stages of the trip data contained in online and in offline cookies is merged.

The capture of users' physical behaviour is achieved by a plurality of sensors. Some of these sensors are integrated in smart devices, such as a GPS sensor; Other sensors may be wearable sensors worn by some users, such as for example odometer sensors integrated on fitness devices that have become increasingly popular; yes other sensors may be fitted in the surrounding environment such as location sensors that increasingly are applied in shops and even in some airports.

The behaviour captured is always context related to each stage of the trip and is and is interpreted on the basis of other available data at the specific time at each stage of the trip. For example, a user's physical behaviour is detected through sensors as a fast pacing up and down near the departure gate. In this example, other data about the trip may indicate that the flight is being delayed. The physical behaviour detected through the sensors may be interpreted as frustration. The cookie for that stage of the trip will capture the interpretation of the behaviour. In this example the interpretation is an emotion, and specifically the emotion of frustration. The emotion captured by the cookie is then related to other data concerning the trip. The information that is provided to the user is selected and provided in response to the captured emotions. For example, when an emotion captured in case of flight delay is frustration, and based on other trip data the system can conclude that the user is likely to miss a connecting flight, the information provided will provide alternatives in case that the delay continues to the point that the user indeed misses the connecting flight. If in this case for example, the information provided shows that the airline will be able to place the user in an alternative flight 1 hour later, this information can be extremely valuable to the user and may make the user feel relieved.

The user's physical location is one of the most important data captured. The capture of the user's physical location is a key element to the update of the user's profile. A user's profile and a user's Graph is always linked to time and spatial location attributes. Spatial location attributes are always defined in relation to local maps. For example, when a user is an airport his location may be interpreted as being near a departure gate.

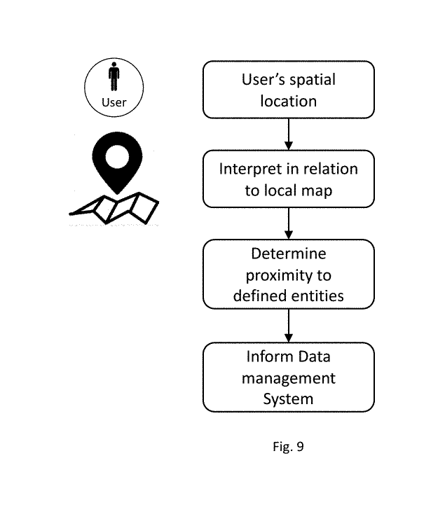

FIG. 9 illustrates how the user's location is captured, interpreted, and used to inform the Data Management System. The Data Management system uses this information in multiple ways, for example in adjusting weights as part of the WRS.

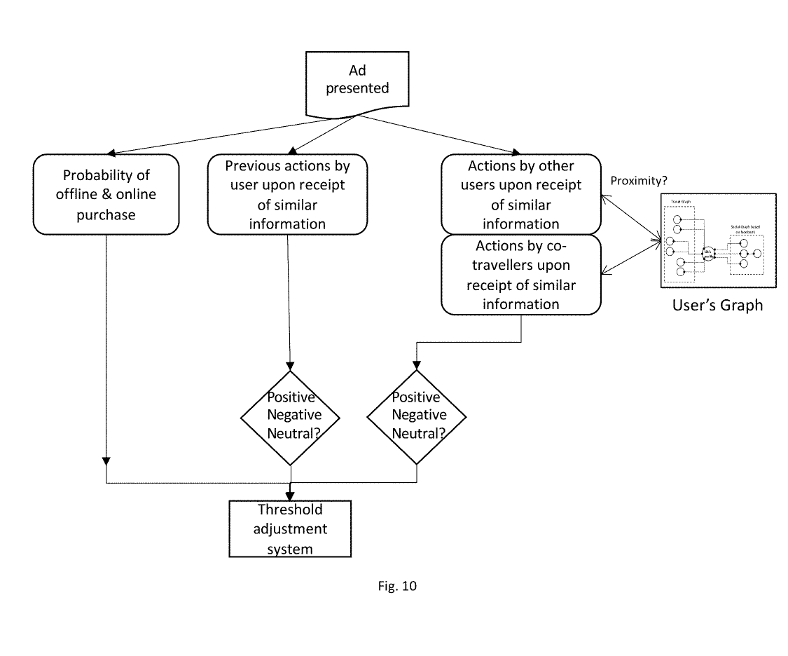

FIG. 10 illustrates how the system for the adjustment of the threshold, with which the ARC is compared, is taking into consideration probability of purchase, response by the user in terms of previous actions by user upon receipt of similar information, and, response by others in terms of previous actions by others upon receipt of similar information.

The method for determining when to stop delivering advertisements, of this invention, is focused on travelers. The method determines when to stop delivering advertisements about a specific product to travelers, the advertisements are, at least once, provided while travelers are onboard public transport means. The method comprising:
providing travelers with access to content and connection to internet through a communication platform and a mobile device app
creating a set of variables that characterize a traveler's profile, interests, trip conditions, and physical or virtual behavior, said variables based on online and offline behavior
creating a set of conditions that characterize a trip
creating a set of time windows that characterize a trip
serving a traveler with ads while the traveler is onboard the aircraft
registering a traveler's virtual behavior while the traveler is onboard, before and after an ad is served
communicating via the communication platform to a central online server information about ads served and traveler behavior
validating the ads received by the traveler while onboard the aircraft, and
determining whether the serving of ads about a product or product category should continue to be served or terminated

A key characteristic of this method characterized in that a weighted average of said variables is determined at each stage of the trip, wherein different weights are applied at each stage of the trip to determine an Ad Relevance for Continuation (ARC), said weighted ARC is compared to thresholds, and an advertisement is served again within the time window of each stage of the trip if the weighted average is above the threshold at the current stage of the trip, or an advertisement is terminated if the weighted average is below the threshold at the current stage of the trip. Different thresholds are applied at each stage of the trip.

The ARC is calculated based on product desirability, likelihood that conversion has happened, and likelihood that conversion will happen within one of the time windows of the trip.

An onboard communication platform generally comprises a retailing and content provision platform and generally this comprises an interfacing platform for providing access to internet to registered users, whilst onboard a public transportation means such as an aircraft, a ship or a train.

A trip is often characterized by certain conditions such as about scheduled and estimated time of arrival, weather conditions at destination as forecasted. These conditions influence a travelers mood, behavior, and willingness to receive ads and act positively on them with an interest to purchase or negatively with an annoyance when such ad is received. Weather is a good example of this; an ad about taxis at the destination may be more effective when it is raining rather than when not. Such conditions can change, and so the system should have most up to date information about such conditions both prior to departure (for example of the airplane) and if possible, at the time when an ad is served. Wherein discrepancies between predicted and estimated conditions have a positive or negative influence on the desirability of a product, to the willingness or ability to buy, this influence is probabilistically calculated and considered in relation to other variables in order to calculate said ARC.

During travel, there are time windows between one stage and another. Time windows as used in this invention, are set according to estimated arrival and departure times, adjusted for dead period, wherein dead periods are the periods where devices may not be used, or passengers may be occupied with embarkation or security procedures. Time windows match periods of the stages of the trip, said stages of the trip comprise period when a traveler is on airplane, train, bus, or ship when the traveler may utilize the on-board communicating platform; period from first arrival to station of arrival to exiting station of arrival; period at destination; arrival at station for next departure, wherein next departure may comprise an intermediate destination or return to starting point; and completion of trip.

While on board a transportation means (for example an airplane) a user can be thought to have a physical and a virtual behavior. A user's virtual behavior while onboard comprises consumption of offline content via the communication platform, browsing of retail pages offline via the communication platform, purchases of goods from the airline retail shop, connection to internet via the communication platform. Purchases via the airline retail shop are evaluated to determine whether a conversion from an ad has taken place, whether a product alternative to the ad has been purchased, whether a product complimentary to the ad has been purchased.

Variables concerning virtual behavior comprise search of item both through the airline retail shop and via online retailers, wherein a value is calculated based on the search both online and through the airline retail system, number of alternative online retailers checked, search of product characteristics in search for alternatives, visit to specific product comparison websites, viewing of product review pages concerning the product. Variables concerning trip purpose comprise business or leisure wherein this variable is adjusted if the user is accompanied by family on the trip, booked as part of a single booking.

Physical behavior of user is assessed based on the duration of time the user spends at the proximity of a physical store in relation to the time window at each stage of the journey.

User's behavior whilst onboard the aircraft and behavior whilst outside the aircraft and both used to assess interest in relation to the content of an ad.

Further variables that are taken into consideration by the invented method comprise interest of other users with similar characteristics according to the user's social graph, wherein said social graph comprises a travel graph and a facebook social graph.

The validation of the ads received by the user while onboard the aircraft is implemented once the user's mobile device establishes internet connection and comprises establishing communication between the app on the users' mobile device and a central online server and communicating to a central online server a unique identifier of ads received.

After trip completion, data is stored onto the app about the products for which an ad was served and a positive response above a minimum threshold was registered wherein the last time window for a trip for ads handled through the app, expires a certain time after trip completion. Thresholds are adjusted dynamically based on the number of times an ad is served.

1. A method for determining when to stop delivering advertisements about a specific product to travelers, the advertisements are, at least once, provided while travelers are onboard public transport means, the method comprising:
providing travelers with access to content and connection to internet through a communication platform and a mobile device app
creating a set of variables that characterize a traveler's profile, interests, trip conditions, and physical or virtual behavior, said variables based on online and offline behavior
creating a set of conditions that characterize a trip
creating a set of time windows that characterize a trip
serving a traveler with ads while the traveler is onboard the aircraft
registering a traveler's virtual behavior while the traveler is onboard, before and after an ad is served
communicating via the communication platform to a central online server information about ads served and traveler behavior
validating the ads received by the traveler while onboard the aircraft, and
determining whether the serving of ads about a product or product category should continue to be served or terminated
said method characterized in that a weighted average of said variables is determined at each stage of the trip, wherein different weights are applied at each stage of the trip to determine an Ad Relevance for Continuation (ARC), said weighted ARC is compared to thresholds, wherein different thresholds are applied at each stage of the trip,
and an advertisement is served again within the time window of each stage of the trip if the weighted average is above the threshold at the current stage of the trip, or an advertisement is terminated if the weighted average is below the threshold at the current stage of the trip.

2. A method according to claim 1, wherein said ARC is calculated based on product desirability, likelihood that conversion has happened, and likelihood that conversion will happen within one of the time windows of the trip.

2. A method according to claim 1, wherein said onboard communication platform comprises a retailing and content provision platform

3. A method according to claim 1, wherein said onboard communication platform comprises an interfacing platform for providing access to internet to registered users, whilst onboard a public transportation means such as an aircraft, a ship or a train.

4. A method according to claim 1, wherein conditions that characterize the trip comprise conditions about scheduled and estimated time of arrival, weather conditions at destination as forecasted prior to departure, and as predicted at the time when an ad is served.

5. A method according to claim 1, wherein discrepancies between predicted and estimated conditions have a positive or negative influence on the desirability of a product, to the willingness or ability to buy, said influence is probabilistically calculated and considered in relation to other variables in order to calculate said ARC.

6. A method according to claim 1, wherein time windows are set according to estimated arrival and departure times, adjusted for dead period, wherein dead periods are the periods where devices may not be used, or passengers may be occupied with embarkation or security procedures.

7. A method according to claim 1, wherein a user's virtual behavior while onboard comprises consumption of offline content via the communication platform, browsing of retail pages offline via the communication platform, purchases of goods from the airline retail shop, connection to internet via the communication platform.

8. A method according to claim 1 or claim 7, wherein purchases via the airline retail shop are evaluated to determine whether a conversion from an ad has taken place, whether a product alternative to the ad has been purchased, whether a product complimentary to the ad has been purchased.

9. A method according to claim 1, wherein variables concerning virtual behavior comprise search of item both through the airline retail shop and via online retailers, wherein a value is calculated based on the search both online and through the airline retail system, number of alternative online retailers checked, search of product characteristics in search for alternatives, visit to specific product comparison websites, viewing of product review pages concerning the product.

10. A method according to claim 1, wherein variables concerning trip purpose comprise business or leisure wherein this variable is adjusted if the user is accompanied by family on the trip, booked as part of a single booking.

11. A method according to claim 1, wherein physical behavior of user is assessed based on the duration of time the user spends at the proximity of a physical store in relation to the time window at each stage of the journey.

12. A method according to claim 1, wherein behavior whilst onboard the aircraft and behavior whilst outside the aircraft and both used to assess interest in relation to the content of an ad.

13. A method according to claim 1, wherein further variables comprise interest of other users with similar characteristics according to the user's social graph, wherein said social graph comprises a travel graph and a facebook social graph.

14. A method according to claim 1, wherein validating the ads received by the user while onboard the aircraft is implemented once the user's mobile device establishes internet connection and comprises establishing communication between the app on the users' mobile device and a central online server and communicating to a central online server a unique identifier of ads received.

15. A method according to claim 1, wherein said time windows match periods of the stages of the trip, said stages of the trip comprise period when a traveler is on airplane, train, bus, or ship when the traveler may utilize the on-board communicating platform; period from first arrival to station of arrival to exiting station of arrival; period at destination; arrival at station for next departure, wherein next departure may comprise an intermediate destination or return to starting point; and completion of trip.

16. A method according to claim 1, wherein after trip completion, data is stored onto the app about the products for which an ad was served and a positive response above a minimum threshold was registered wherein the last time window for a trip for ads handled through the app, expires a certain time after trip completion.

17. A method according to claim 1, wherein said thresholds are adjusted dynamically based on the number of times an ad is served.
